(19) United States
(12) Patent Application Publication
(10) Pub. No.: US 2007/0062062 A1
(43) Pub. Date: Mar. 22, 2007

(54) Nozzle blowing case of a tenter frame

(76) Inventors: Kurt Van Wersch, Wegberg (DE); Norbert Sieben, Monchengladbach (DE)

Correspondence Address: WILLIAM COLLARD;COLLARD & ROE, P.C., 1077 NORTHERN BOULEVARD, ROSLYN, NY, 11576, US

(21) Appl. No.: 10/570,935

(22) PCT Filed: Sep. 8, 2004
(86) PCT No.: PCT/DE04/01992

§ 371 Date: Mar. 8, 2006

(30) Foreign Application Priority Data
Sep. 19, 2003 (DE) 103 43 407.0

(51) Int. Cl. F26B 3/00; F26B 13/00

(52) U.S. Cl. 34/444; 34/448; 34/638

(57) ABSTRACT

The invention relates to a nozzle blowing case of a tenter frame for treating a textile web of fabric by blowing it with a treatment agent stream either form hole-type nozzles or from a slotted nozzle extending transversal to the direction of conveyance of the web of fabric. In order to simplify the switching of the treatment agent stream from the hole-type nozzles to the slotted nozzles (and reversed), a moving slide is assigned to the blow-out surface of the blowing case that, in one position, closes the slotted nozzle and, in another position, closes the hole-type nozzles.

The invention relates to a nozzle blowing case of a tenter frame for treating a textile web of fabric that is spread out and moved in its longitudinal direction, optionally from at least two different types of nozzles, with a treatment agent stream, whereby the nozzles are provided in a blow-out surface that extends parallel to the surface of the fabric web, whereby a slide that is mounted to move within the blowing case is provided for selecting the nozzle type that is desired, in each instance, and whereby the slide possesses passage holes that open the path of the treatment agent stream through the one nozzle type in one position of the slide, and through the other nozzle type in the other position of the slide. The term “blow-out surface” is to be understood generally. For example, the blow-out surface can contain the nozzles (as holes), or it can be configured as a holding means/framework for the nozzles.

A nozzle configuration of this type is described in the German Auslegeschrift 11 96 156 (DE 11 96 156 B1). The known nozzle configuration is intended for combined tenter frames/suspension dryers having blowing cases, whose distance from the treated textile fabric web can be changed. In this connection, the blow-out surface of the blowing cases, in each instance, is supposed to consist of a first bottom sheet of metal, which has larger and smaller outflow openings (nozzles) alternately in one plane. On this bottom sheet, a second bottom sheet of metal, also referred to as a slide, is supposed to be mounted in displaceable manner, parallel (to the first bottom sheet), which second sheet possesses only the larger openings, in the same pattern as the first bottom sheet. By means of relative movement of this slide, its openings can optionally be brought into coverage with the larger or the smaller openings of the first bottom sheet. For the corresponding adjustment, the slide is moved essentially crosswise to the transport direction, i.e. crosswise to the longitudinal direction of the treated fabric web.

In the known art, two different sizes of hole-type nozzles are provided in the blow-out surface of the blowing case. Round or angular hole-type nozzles were introduced because a relatively high evaporation output can be achieved using these nozzles. Smaller and more closely adjacent hole-type nozzles are used, for example, in the case of fabric grades for which there is the risk that the broader nozzle jets will produce stripes on the fabric web. However, it is not possible to entirely overcome the risk of stripe formation even when using small hole-type nozzles.

The invention is based on the task of creating a nozzle application to the web of fabric, for the blow-out surface of the blowing case, which can be optionally adjusted or blocked by means of the slide, which application is guaranteed not to leave or produce any stripes on the fabric web. The solution according to the invention is described in claim 1. Some improvements and additional embodiments of the invention are indicated in the dependent claims.

For the nozzle case described initially, the solution according to the invention preferably consists in the fact that a slotted nozzle that extends crosswise to the longitudinal direction, over the width of the fabric web, which can also be referred to as a nozzle slot, is provided in the blow-out surface, as an outflow alternative to a plurality of hole-type nozzles, to be opened and blocked, respectively, by means of the slide.—In the case of the known nozzle blowing case, it is true that one was able to achieve an improvement with regard to freedom from stripes, by means of reducing the size and correspondingly increasing the number of the hole-type nozzles, but there are fabric grades on which even very small hole-type nozzles leave a mark. This problem, in particular, is overcome according to the invention, by means of the slotted nozzles that can be turned on as an alternative to or counter to hole-type nozzles.

Preferably, the slide provided for switching over the nozzles is mounted to move crosswise to the longitudinal direction of the fabric web. However, other displacement directions, for example in the longitudinal direction of the fabric web, or at a slant with regard to the longitudinal direction, are also possible within the scope of the invention. The slide is fundamentally supposed to release the treatment agent passage through one nozzle type in the one position, and through the other nozzle type in the other position.

The slide is preferably supposed to be configured essentially in one piece. However, within the scope of the invention it can also have two or more pieces. For example, the slide can consist of two parts that either spread open (release) or clamp off (block) one slotted nozzle between themselves, in other words between two slide edges that face one another; at the same time, the slide parts are then supposed to either block or release the hole-type nozzles that are to be controlled (the opposite as for the slot).

Furthermore, two or more than two nozzle types can be available for a selection by the slide. Within the scope of the invention, variations are also possible with regard to blocking or opening the one nozzle type or the other; for example, different nozzle types can be simultaneously opened or closed in part or completely.

For example, if a fabric web is supposed to be carried on an air cushion or guided between two air cushions, it can be desirable, i.e. advantageous to make the volume stream of the treatment gas the same not only in the various modes of operation, but also to keep it constant when switching from the one mode of operation to the other. In this connection, volume stream is the total stream that passes through the nozzles and impacts the web. According to other embodiments, the slides (and/or nozzle openings) are supposed to be configured in such a manner that the current sum of the slot/hole opening degrees, for example of the open cross-sections, and thereby the volume stream that flows through the totality of the currently open cross-sections, practically does not change when the switch occurs. In this connection, it also lies within the scope of the invention to gradually change the volume stream when switching, i.e. without steps, for example to increase it or decrease it.

It is essential within the scope of the invention to equip the outflow surface of the nozzle blowing cases with hole-type nozzles and at least one slotted nozzle that extends crosswise to the fabric web surface, over the entire width of the latter, and to provide a slide that can be used to choose between the hole-type nozzles and the slotted nozzle, in the manner described above. The hole-type/slotted nozzle design according to the invention does not have to be present everywhere in the tenter frame and/or configured in the same manner. Often, it is sufficient to equip the outflow surfaces that face a sensitive side of the fabric web surface with the nozzle combination, at the machine end (viewed in the transport direction), for example in the last field of a tenter frame.

The slotted nozzles are supposed to extend over the entire width of the fabric web. For technical reasons, it is often necessary, in this connection, to provided narrow crosspieces in the slotted nozzles, which mechanically stabilize the nozzle slot, which sometimes has a length of three and more meters, as a whole. However, the crosspieces that stand crosswise to the longitudinal direction of the nozzle slot are supposed to be made so thin that they have practically no negative influence on the treatment agent stream that passes through the slot, at least not so as to disrupt it.

As experience has shown, a slotted nozzle provides a relatively lower evaporation output as compared with hole-type nozzles. For this reason, a tenter frame or blowing case is supposed to be operated with a partially or completely open slotted nozzle only if that is absolutely necessary, for example in order to achieve freedom from stripes. It can actually be advantageous to blow air onto the fabric web simultaneously from hole-type nozzles and slotted nozzles, so that the desired evaporation output is achieved by means of the hole-type nozzles, and the desired freedom from stripes or a similar advantage is achieved by means of the slotted nozzle. In this connection, the invention permits setting the slide more or less wide in the direction of the slotted nozzle opening or in the direction of the hole-type nozzle opening, in accordance with the requirements of the individual textile fabric webs being treated.

Within the scope of the invention, various designs are possible for the design of the blow-out surface with slide and nozzles.

A preferred embodiment of the slide for selecting between slotted nozzle operation and hole-type nozzle operation consists in the fact that the slide, similar to the blow-out surface, has holes and at least one slot (that extends over the entire fabric web width). However, a distance between the slot and the group of holes that is different by more than one slot width, for example, is supposed to be provided there, in such a manner that the slide blocks the holes in one position and blocks the slot in the other position. Such a slide for blocking and opening a nozzle slot that extends crosswise to the longitudinal direction of the fabric web is displaced by at least one slot width (measured in the longitudinal direction of the fabric web) in the longitudinal direction, to switch from slot operation to hole operation or vice versa.

Within the scope of the invention, a slide in which the distribution of holes and nozzle slot is provided in the same manner (i.e. with the same coverage) as in the blow-out surface is also possible. In this case, a special opening and closing mechanism, for example a shutter, can be assigned to the slide. If such a shutter slide is supposed to be adjustable crosswise to the longitudinal direction of the fabric web, the design can be configured in such a manner, according to a further development of the invention, that the nozzle slot is closed by the shutter in one slide position, but the holes of the slide come into coverage with the holes of the blow-out surface, and in the other slide position, the shutter and thereby the slot are open, but the holes of the blow-out surface are blocked (by the surface of the slide).

In a preferred further variant for switching the blowing case from hole-type nozzle operation to slotted nozzle operation and vice versa, a system that can be switched according to the invention and consists of passage holes that can be displaced relative to one another by means of the slide movement precedes the slot (in the flow direction of the treatment agent), so that optionally, the access of the treatment agent stream to the slot or the hole-type nozzles can be blocked. Preferably, in this connection, the blow-out surface is supposed to possess a nozzle slot that extends in the adjustment direction of the slide as an outflow alternative to a plurality of hole-type nozzles, as well as a tunnel that bridges the slot on its entire length, towards the interior of the blowing case, having tunnel holes that are offset relative to the hole-type nozzles, which tunnel holes form the connection (from the interior of the blowing case) to the slot. An additional advantage in the case of this design consists in the fact that the treatment agent is passed to the nozzle slot, when the access to the latter is opened, by way of tunnel holes that are advantageously angular, so that despite the use of a nozzle slot, a relatively great evaporation output is achieved, with freedom from stripes.

In the case of the latter design, the slide that is perforated (in accordance with the hole-type nozzles) is supposed to possess additional passage holes in its region that is adjacent to the tunnel, which passage holes are to be brought into coverage with the tunnel holes in the one slide position, and guide the treatment agent stream through the tunnel holes and the slotted nozzle. The slide is therefore supposed to have two types of passage holes. The one hole type is supposed to be able to be brought into coverage with the hole-type nozzles in one slide position, and the other hole type is supposed to be able to be brought into coverage with the tunnel holes in the other slide position. In other words: Part of the passage holes of the slide is supposed to come into coverage with the hole-type nozzles in the one slide position, and another part of the passage holes of the slide is supposed to come into coverage with the tunnel holes in another slide position.

By means of the invention, it becomes possible, in the simplest manner, to optionally use a tenter frame in hole-type nozzle operation and in slotted nozzle operation. The switch of the tenter frame, according to the invention, makes it possible to switch over from one treatment type to the other in the fastest possible manner, and even to set intermediate positions, so that goods of different grades can be treated quickly, one after the other, using one and the same machine, without stripes and at optimal evaporation output.

Details of the invention will be explained using the schematic representation of exemplary embodiments. These show:

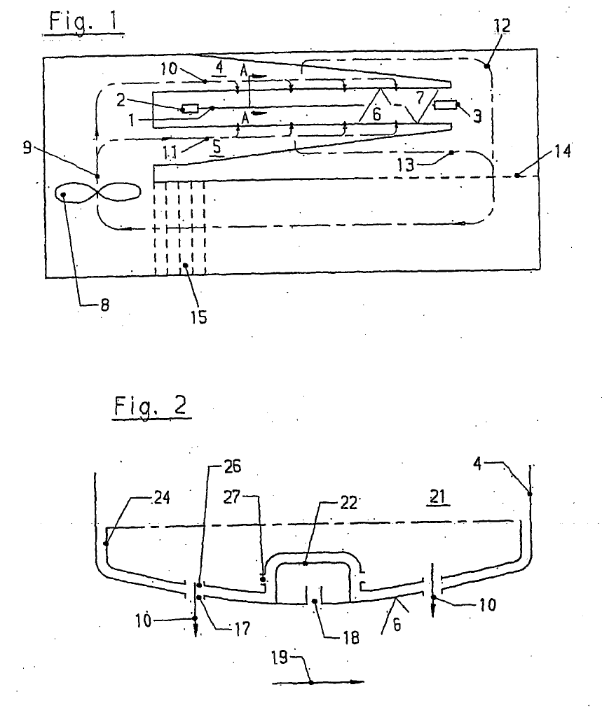

FIG. 1 a cross-section crosswise to the fabric web transport direction, through a tenter frame;

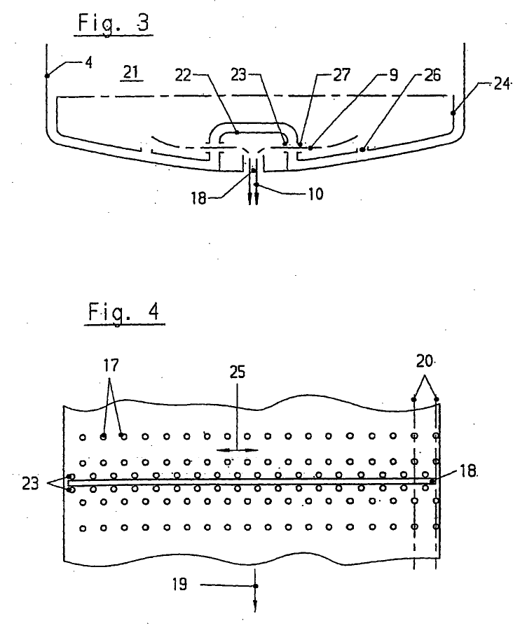

FIGS. 2 and 3 a cross-section along the line A-A of FIG. 1, for two different slide positions;

FIG. 4 a top view of the blow-out surface;

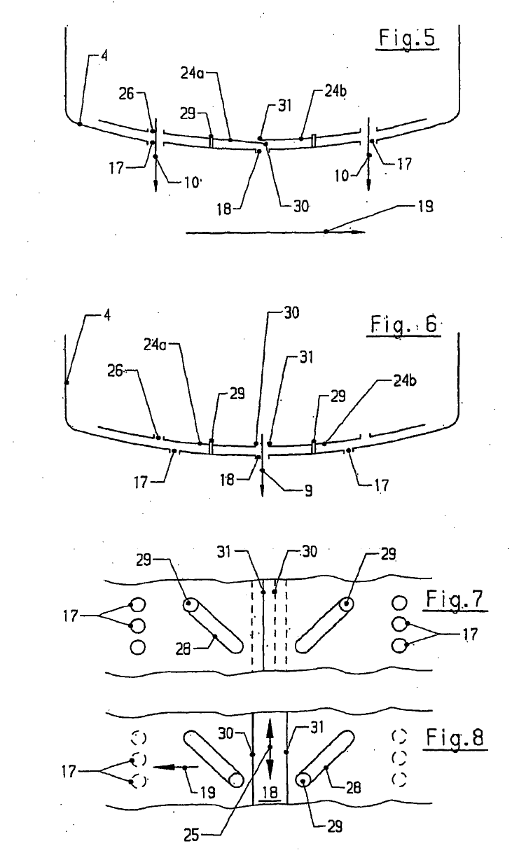

FIG. 5 to 8 a cross-section as in FIGS. 2 and 3, with a variation of a slide; and

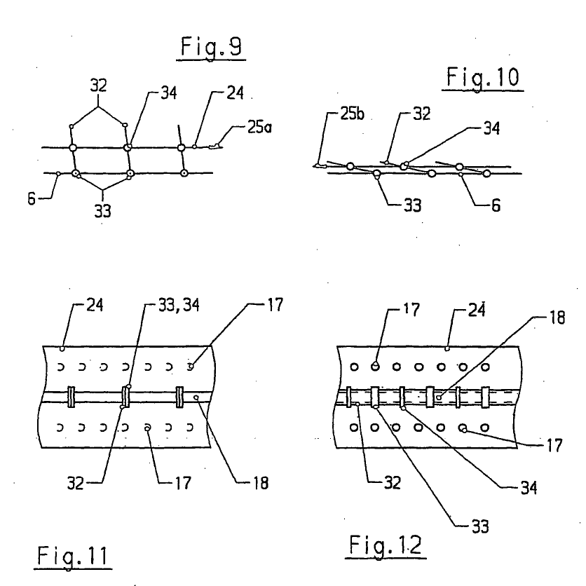

FIG. 9 to 12 a further variation of a slide, with a representation of different positions.

FIG. 1 schematically shows a vertical cross-section, perpendicular to the longitudinal direction of a tenter frame. During operation of the tenter frame, the spread-out textile fabric web 1 to be treated is held in chains 2 and 3 on its longitudinal edges, in its transport direction, i.e. its longitudinal direction, in other words in the direction perpendicular to the plane of the drawing, and guided horizontally between two blowing cases 4 and 5. The one blowing case, namely the upper blowing case 4, is situated above the fabric web 1, and the other blowing case, namely the blowing case 5, is situated below the fabric web 1. Each of the blowing cases possesses a blow-out surface 6 and 7 (parallel to the fabric web 1), respectively, which serves to bring a treatment agent stream 9 to the fabric web 1, using a fan 8.

With the help of the upper blowing case 4, partial streams 10 are directed onto the fabric web 1 from the top, from nozzles (not shown in detail in FIG. 1), while partial streams 11 of the treatment agent stream 9 impact the fabric web 1 from below, from the lower blowing case 5. The partial streams 10, 11 are either reflected at the fabric web 1, or they flow through the web and then flow back to the fan 8, for example through slots (not shown) of the blowing case 4, 5, in each instance, as a return stream 12, 13, often through a screen 14 and a heat exchanger 15.

There are numerous more or less fundamental deviations from this fundamental structure according to FIG. 1, to which the invention can be applied. The actual invention, namely a blowing case that can be optionally switched to hole-type operation and slotted nozzle operation, is explained using FIGS. 2 to 12.

FIGS. 2 and 3 are to be viewed as a cross-section along the line A-A of FIG. 1, through part of the upper blowing case 4 and through the fabric web 1. In the drawing, a blowing case is presumed whose blow-out surface 6 has a plurality of hole-type nozzles 17 and at least one slotted nozzle 18. FIG. 4 shows a partial view of the blow-out surface 6 of an upper blowing case 4 matching FIGS. 2 and 3. The longitudinal direction, i.e. transport direction 19 of the fabric web 1 is indicated with an arrow. The hole-type nozzles 17 are disposed in rows 20, which lie essentially parallel to the longitudinal direction 19 of the fabric web and lie crosswise to the longitudinal expanse of the slotted nozzle 18.

In the preferred exemplary embodiment according to FIG. 2 to 4, a tunnel 22 that bridges the slotted nozzle 18 over its entire length, towards the interior 21 of the blowing case, having tunnel holes 23 that form the connection to the slotted nozzle 18, offset relative to the hole-type nozzles 17 (crosswise to the longitudinal direction 19), is provided. In the interior 21 of the blowing case, there is a slide 24 that is adjustable relative to the blow-out surface 6 (displaceable parallel to it), in the slot longitudinal direction 25 of the slotted nozzle 18. The slide 24 possesses two types of passage holes, namely passage holes 26 that come into coverage with the hole-type nozzles 17 in one slide position (movement in the slot longitudinal direction 25), and passage holes 27 that come into coverage with the tunnel holes 23 in another slide position, in other words release the tunnel holes 23 for passage of the treatment agent stream 9.

In FIG. 2 to 4, the hole-type nozzles 17 and the tunnel holes 23 are shown offset relative to one another in the slot longitudinal direction 25, while the passage holes 26, 27 of the slide 24 lie in a row (parallel to the longitudinal direction 19), in each instance. Instead, the hole-type nozzles 20 and the tunnel holes 23 can also be disposed in a row parallel to the longitudinal direction 19, and the passage holes 26 and 27 can be disposed offset in the slot longitudinal direction 25, accordingly. Above all, the slide 24 is supposed to block the hole-type nozzles 17 in one of its longitudinal positions, but release the tunnel holes 23 for the through-flow of the treatment agent stream 9, and in the other longitudinal position, release the hole-type nozzles 17, but be able to block the tunnel holes 23. In the first case, the treatment agent stream 9 flows in the direction of the fabric web 1 by way of the tunnel holes 23 and the slot 17. In the other case, the treatment agent stream 9 also flows to the fabric web 1, through the hole-type nozzles 17.

In FIGS. 5 and 6, a cross-section along the line A-A of FIG. 1 is also shown, but with a variation of the slide 24 as compared with FIGS. 2 and 3. Again, hole-type nozzles 17 alternative to a slotted nozzle 18 are presumed in the blowing case 4. In this exemplary embodiment, the slide consists of two parts 24a and 24b, which can be displaced relative to one another, at least with one component, parallel to the longitudinal direction 19 of the fabric web to be treated, in order to open either the hole-type nozzles 17 or the slotted nozzle 18 for passage of the treatment agent stream 9, in each instance. In the exemplary embodiment, an adjustment mechanism for the two slide parts 24a and 24b is provided, the function of which can be seen in FIG. 7 and 8. Each slide part can possess a pin guide 28, which lies at a slant with reference to the longitudinal direction 19 and therefore approximately diagonal to the longitudinal direction 19 of the fabric web and the slot longitudinal direction 25. A pin 29, which is fixed in place on the blowing case 4, projects through each guide 28. If one pulls or pushes the slide parts 24a and 24b relative to the pin 29, in the slot direction 25, by means of some kind of outside actuator, the longitudinal edges 30, 31 of the slide parts 24a and 24b, which edges face one another, are pushed towards one another (FIG. 7) or pulled apart (FIG. 8). In the first case, the hole-type nozzles 17 are opened (for example by means of holes provided in the surface of the slide parts 24a, b), and the slot 18 is blocked (by means of the abutting or overlapping of the longitudinal edges 30, 31); in the other case (FIG. 8), the hole-type nozzles 17 are blocked (for example by means of surface parts of the slide parts 24a, b, in each instance), and the slot 18 is opened.

Another exemplary embodiment for a mechanism for exchanging hole-type nozzles 17 for a slotted nozzle 18 and vice versa is shown, in principle, using FIG. 9 to 12. In this case, louver flaps 32 are attached above the slot 18 of the blowing case 4, on pivot joints 33. To activate the louver flaps 32, a slide 24 is provided, according to FIGS. 9 and 10, on which the louver flaps 32 are attached in articulated manner (as shown), for example with bearings 34. The pivot joints 33 can be mounted, for example, on both sides of the slot 18, on the blow-out surface 6 of the blowing case 4, so that the pivot axes lie approximately crosswise to the slot longitudinal direction 25. If one pulls the slide 24 in the direction of the arrow 25a, according to FIG. 9, the louver flaps 32 are set essentially perpendicular to the blow-out surface 6, so that the passage for the treatment agent stream 9 is released. FIG. 11 shows this position of the louver flaps 32 in a top view of the slotted nozzle 18. If one pulls the slide 24 in the direction of the arrow 25b according to FIG. 10, the louver flaps 32 are accordingly laid flat on the blow-out surface 6, and thereby onto the slot 18, so that the latter is blocked for passage of the treatment agent stream 9, according to FIG. 12.

In order to open and close the hole-type nozzles 17 (alternatively or counter to the slot), at the same time, with the slide 24 according to FIG. 9 to 12, the slide is equipped with passage holes 26 on both sides of the louver flap bearing 34 (in the exemplary embodiment shown), which lie next to the hole-type nozzles 17 when the louver flaps 32 are lifted up according to FIGS. 9 and 11, so that the hole-type nozzles 17 are closed off by means of the surface of the slide 24, and come into coverage with the hole-type nozzles 17 when the louver flaps 32 are laid flat, according to FIGS. 10 and 12, so that the treatment agent stream 9 can flow through the hole-type nozzles 17.

In the exemplary embodiment according to FIG. 2 to 12, it is provided that the slide 24, which lies on the inside (within the blowing case 4), is movable relative to the blowing case, which is fixed in place. In this connection, however, all that is important is a relative movement; fundamentally, the outer blow-out surface 6 having the hole-type nozzles 17 and the slotted nozzle 18 could also be configured to be displaceable in the direction of the arrow 25 relative to an inner part having the passage holes 26 and 27 (in other words the slide and blow-out surface could be interchanged).

Furthermore, the invention is described for a tenter frame having a fabric web 1 stretched crosswise to the longitudinal direction, i.e. transport direction 19, using chains 2, 3. Alternatively to such a tenter frame, a suspension dryer with or without chains, i.e. crosswise tension can also be used. The invention is also applicable to a dryer that possess a blowing case 4 or 5, respectively, only above or only below the fabric web 1. The fabric web can also be carried through the treatment zone using a screen belt. Independent of the application, for example also when drying paper or the like, and of the structure of the machine, for example also in the case of a multi-level machine, the important thing within the scope of the invention is to be able to replace a slotted nozzle of any kind, which extends crosswise to the transport direction of the web being treated, with hole-type nozzles (also of any kind), using few manipulations, and vice versa. The term “tenter frame” therefore comprises all the aforementioned machines that are possibilities for using the invention.

### REFERENCE SYMBOL LIST

1=fabric web
2, 3=chains
4, 5=blowing case
6, 7=blow-out surface
8=fan
9=treatment agent stream
10, 11=partial streams
12, 13=return streams
14=screen
15=heat exchanger
17=hole-type nozzle
18=slotted nozzle
19=longitudinal direction (1)
20=row of hole-type nozzles
21=interior of blowing case
22=tunnel
23=tunnel hole
24=slide
25=longitudinal direction of slot
26, 27=passage holes (24)
28=guide (29)
29=pin
30, 31=longitudinal edges (24a, 24b)
32=louver flaps
33=pivot joint
34=bearing

1. Nozzle blowing case (4) of a tenter frame for treating a textile web (1) of fabric that is spread out and moved in its longitudinal direction (19), optionally from at least two different types of nozzles, with a treatment agent stream (9), whereby the nozzles are provided in a blow-out surface (6) that extends parallel to the surface of the fabric web, whereby a slide (24) that is mounted to move within the blowing case (4) is provided for selecting the nozzle type that is desired, in each instance, and whereby the slide (24) possesses passage holes that open the path of the treatment agent stream (9) through the one nozzle type in one position of the slide, and at least partially through the other nozzle type in the other position of the slide, wherein a slotted nozzle (18) that extends over the width of the fabric web (1) in the longitudinal direction (19) is provided in the blow-out surface (6), as an outflow alternative to a plurality of hole-type nozzles (17), to be opened and blocked, respectively, by means of the slide (24).

2. Nozzle blowing case according to claim 1, wherein a system that can be switched and consists of passage holes (23, 27) to be opened or closed, respectively, by means of a slide movement, preferably in opposed manner, precedes the slotted nozzle (18) in the flow direction of the treatment agent (9).

3. Nozzle blowing case according to claim 2, wherein the passage holes (23) are configured to be angular, in the sense of producing a high evaporation output.

4. Nozzle blowing case according to claim 1, wherein a slotted nozzle (18) that extends crosswise to the longitudinal direction (19) of the fabric web, in the adjustment direction (25) of the slide (24), is provided in the blow-out surface (6), as an outflow alternative to a plurality of hole-type nozzles (17), and that a tunnel (22) that bridges the slotted nozzle (18) on its entire length, towards the interior (21) of the blowing case, having tunnels holes (23) that are offset relative to the hole-type nozzles (17), forming the connection to the slotted nozzle (18), is provided (FIG. 2 to 4).

5. Nozzle blowing case according to claim 4, wherein the slide (24) possesses passage holes (27) in its region adjacent to the tunnel (22), which are to be brought into coverage with the tunnel holes (23) in one slide position.

6. Nozzle blowing case according to claim 4, wherein the slide (24) possesses two types of passage holes (27, 28), of which the one type is to be brought into coverage with the hole-type nozzles (17) in one slide position, and the other type is to be brought into coverage with the tunnel holes (23) in another slide position.

7. Nozzle blowing case according to claim 1, wherein a slide (24) is provided, which possesses passage holes (26) to be brought into coverage with the hole-type nozzles (17), and which is displaceable in a direction crosswise to the longitudinal direction (25) of the slotted nozzle (18), in such a manner that it blocks the slotted nozzle (18) when its passage holes (26) come into coverage with the hole-type nozzles (17), and blocks the hole-type nozzles (17) when it releases the slotted nozzle (18) (FIG. 5 to 8).

8. Nozzle blowing case according to claim 7, wherein a part (24a, 24b) of the slide is mounted on both sides of the slotted nozzle (18), and that the slide parts are mounted to be movable relative to one another in the direction crosswise to the slot longitudinal direction (25), so that they cover the slotted nozzle (18) with their longitudinal edges (30, 31) that face one another, preferably overlapping, or block the hole-type nozzles (17) with their surface parts that face away from the slot.

9. Nozzle blowing case according to claim 1, wherein the slide (24) possesses passage holes (26) in its surface, which come into coverage with the hole-type nozzles in an advanced position parallel to the slot longitudinal direction (25), and that the slide (24) is coupled with louver flaps (30) 32 that close the slotted nozzle (18), preferably in opposed manner, when the hole-type nozzles (17) are open, and release it when the hole-type nozzles (17) are closed (FIG. 9 to 12).

10. Nozzle blowing case according to claim 1, wherein the slide (24a, b) has two or more parts (FIG. 5 to 8).

11. Nozzle blowing case according to claim 1, wherein the opposed opening or blocking of the various nozzle types is provided at a predetermined total volume stream of the treatment gas that impacts the fabric web, particularly one that remains the same.
